(19) United States
(12) Patent Application Publication
(10) Pub. No.: US 2005/0185127 A1
(43) Pub. Date: Aug. 25, 2005

(54) Method of manufacturing liquid crystal display

(76) Inventors: Natsuko Fujiyama, Ageo-shi (JP); Akio Murayama, Fukaya-shi (JP); Yasushi Kawata, Ageo-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/065,115

(22) Filed: Feb. 24, 2005

(30) Foreign Application Priority Data
Feb. 25, 2004 (JP) 2004-049722

(51) Int. Cl. G02F 1/1345

(52) U.S. Cl. 349/149

(57) ABSTRACT

There is provided a method of manufacturing a liquid crystal display, including arranging a liquid crystal display panel on a stage such that an array substrate faces the stage and, in this state, pressing an end of a flexible printed circuit board against an end of the array substrate with an adhesive layer interposed there between to adhere the flexible printed circuit board to the liquid crystal display panel, wherein the pressing is performed in a state that no layer is interposed between a transparent substrate of the array substrate and the stage or in a state that one or more layers are interposed between the transparent substrate and the stage and all the layers between the transparent substrate and the stage are difficult to be deformed as compared with the transparent substrate when arranged on and pressed against the stage.

### CROSS-REFERENCE TO RELATED APPLICATIONS

This application is based upon and claims the benefit of priority from prior Japanese Patent Application No. 2004-049722, filed Feb. 25, 2004, the entire contents of which are incorporated herein by reference.

### BACKGROUND OF THE INVENTION

1. Field of the Invention

The present invention relates to a method of manufacturing a display and, more particularly, to a method of manufacturing a liquid crystal display, including bonding a flexible printed circuit board to a liquid crystal display panel.

2. Description of the Related Art

Liquid crystal displays have advantages such as lightweight, low profile and low power consumption. Because of these advantages, liquid crystal displays are finding wide application including portable devices.

Recently, a technique of further reducing the weight by polishing the glass substrate after completing the liquid crystal display panel has received a great deal of attention. According to this technique, weight reduction can be implemented. In addition, since the glass substrate can be made thinner, the liquid crystal display panel can be flexible.

However, the present inventors found in making the present invention that the yield in the process of bonding the flexible printed circuit board to the liquid crystal display panel greatly decreases as the glass substrate becomes thin.

### BRIEF SUMMARY OF THE INVENTION

According to a first aspect of the present invention, there is provided a method of manufacturing a liquid crystal display, comprising assembling a liquid crystal display panel including an array substrate comprising a transparent substrate, pixel circuits which are arrayed in a display region on a major surface of the transparent substrate, and an input terminal group which is arranged in a peripheral region adjacent to the display region on the major surface of the transparent substrate and is connected to the pixel circuits, a counter substrate facing the pixel circuits, and a liquid crystal layer interposed between the array substrate and the counter substrate, a first portion of the major surface on which the input terminal group is arranged being exposed to an outside of the liquid crystal display panel, and arranging the liquid crystal display panel on a supporting surface of a stage such that the array substrate faces the supporting surface and, in this state, pressing a second portion of a flexible printed circuit board on which an output terminal group is arranged against the first portion with an adhesive layer interposed between the first and second portions to connect the output terminal group to the input terminal group and to adhere the flexible printed circuit board to the liquid crystal display panel, wherein pressing the second portion against the first portion is performed in a state that no layer is interposed between the transparent substrate and the supporting surface or in a state that one or more layers are interposed between the transparent substrate and the supporting surface and all the layers between the transparent substrate and the supporting surface are difficult to be deformed as compared with the transparent substrate when arranged on and pressed against the supporting surface.

According to a second aspect of the present invention, there is provided a method of manufacturing a display, comprising preparing a glass substrate with a wire and an input terminal formed on a major surface thereof, the input terminal being connected to the wire for supplying the wire with a signal, bonding a circuit board to the glass substrate, wherein bonding the circuit board includes arranging the glass substrate on a stage of a bonding apparatus such that the other major surface of the glass substrate comes in contact with a surface of the stage, arranging the circuit board on an input terminal portion of the glass substrate where the input terminal is formed, and pressing the circuit board against the glass substrate, and after bonding the circuit board, forming a protective layer with a predetermined hardness on an area of the other major surface of the glass substrate which corresponds to the input terminal portion, wherein the surface of the stage which the other surface of the glass substrate contacts in bonding the circuit board has a hardness higher than the predetermined hardness.

### BRIEF DESCRIPTION OF THE SEVERAL VIEWS OF THE DRAWING

FIG. 1 is a perspective view schematically showing a liquid crystal display which can be manufactured by a method according to an embodiment of the present invention;

FIG. 2 is a plan view schematically showing the array substrate of the liquid crystal display shown in FIG. 1;

FIG. 3 is a sectional view schematically showing an example of a structure which can be employed for the liquid crystal display panel of the liquid crystal display shown in FIG. 1;

FIG. 4 is a flowchart schematically showing a liquid crystal display manufacturing method according to an embodiment of the present invention; and

FIG. 5 is a sectional view schematically showing the flexible printed circuit board bonding process in the process shown in FIG. 4.

### DETAILED DESCRIPTION OF THE INVENTION

The embodiment of the present invention will be described below with reference to the accompanying drawing. The same reference numerals denote constituent elements having the same or similar functions throughout the drawing, and a repetitive description thereof will be omitted.

Firstly, a liquid crystal display which can be manufactured by a method according to an embodiment of the present invention will be described.

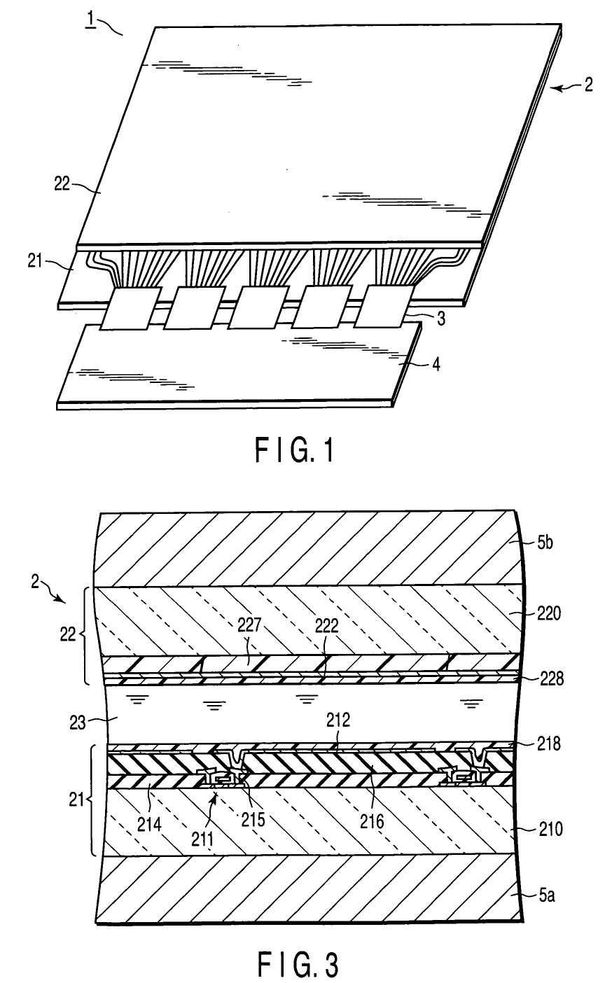

FIG. 1 is a perspective view schematically showing the liquid crystal display which can be manufactured by the method according to an embodiment of the present invention.

A liquid crystal display 1 shown in FIG. 1 includes a liquid crystal display panel 2. The liquid crystal display panel 2 includes an array substrate (or active matrix substrate) 21 and a counter substrate 22 facing the array substrate 21. A seal layer (not shown) made of an adhesive or the like is formed at the periphery between the substrates 21 and 22 except the inlet for liquid crystal (LC) filling. The inlet is sealed by using a sealing agent (not shown). The space surrounded by the array substrate 21, counter substrate 22, and seal layer is filled with a liquid crystal material. The liquid crystal material forms a liquid crystal layer (not shown).

Polarizing films (not shown) serving as polarizers are stuck to both major surfaces of the liquid crystal display panel 2, respectively. A light source (not shown) is arranged on the rear side of the liquid crystal display panel 2.

One end of each flexible printed circuit board 3 is adhered to one end of the array substrate 21. More specifically, the end portion of one major surface of each flexible printed circuit board 3 is adhered to the end portion of the major surface of the array substrate 21, which is located on the side of the counter substrate 22 and exposed from the counter substrate 22, by an adhesive (not shown). In addition, the output terminal groups of the flexible printed circuit boards 3 are connected to the input terminal group of the array substrate 21.

The other end of each flexible printed circuit board 3 is adhered to one end of a circuit board 4 on which a circuit to drive driver integrated circuits (ICs) (not shown) is mounted. The input terminal group of each flexible printed circuit board 3 and the output terminal group of the circuit board 4 are connected by, e.g., soldering. The driver ICs include an X driver to supply a video signal to a signal line and a Y driver to supply a scan signal to a scan line. These drivers are, e.g., formed on one major surface of the array substrate 21 by the same process as that for a pixel circuit (to be described later), bonded to the array substrate 21 as driver IC chips, or bonded to the flexible printed circuit boards 3 as driver IC chips. In this example, the X driver is mounted on each flexible printed circuit board 3 as an IC chip while the Y driver is formed on one major surface of the array substrate 21.

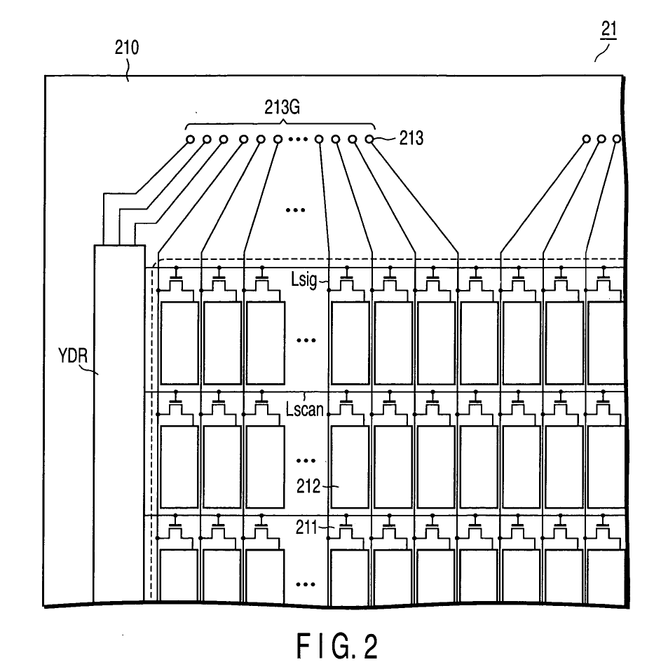

FIG. 2 is a plan view schematically showing the array substrate of the liquid crystal display shown in FIG. 1.

The array substrate 21 shown in FIG. 2 includes a transparent substrate 210 such as a glass substrate. One major surface of the transparent substrate 210 has a display region and a peripheral region surrounding the display region. The boundary between the regions is indicated by a broken line in FIG. 2.

In the display region, a plurality of scan lines L_{scan} and a plurality of signal lines L_{sig} are arranged almost perpendicularly to each other. A thin-film transistor (to be referred to as a TFT hereinafter) 211 with a gate connected to the scan line L_{scan} is arranged, as a switching element, near each of the intersections between the scan lines L_{scan} and the signal lines L_{sig}. In addition, a pixel electrode 212 connected to the signal line L_{sig} through the TFT 211 is also arranged near each intersection. The TFT 211 and pixel electrode 212 form a pixel circuit.

In the peripheral region, a plurality of input terminal groups 213G are arranged along one side of the transparent substrate 210. Input terminals 213 included in the input terminal groups 213G serve as outer lead bonding (OLB) pads. Some of the input terminals are connected to the signal lines L_{sig}. The remaining input terminals 213 are connected to a Y driver YDR formed in the peripheral region. The scan lines L_{scan} are connected to the Y driver YDR.

In the liquid crystal display 1 shown in FIG. 1, the flexible printed circuit board 3 is arranged in correspondence with each input terminal group 213G. The flexible printed circuit board 3 includes a resin film made of a material such as polyimide or polyester, an interconnection pattern supported by the resin film, and various kinds of terminal groups formed on the interconnection pattern. More specifically, each flexible printed circuit board 3 has, on the surface facing the array substrate 21, an output terminal group (not shown) corresponding to the input terminal group 213G of the array substrate 21.

The liquid crystal display panel of the liquid crystal display shown in FIG. 1 will be described next in more detail.

FIG. 3 is a sectional view schematically showing an example of a structure which can be employed for the liquid crystal display panel of the liquid crystal display shown in FIG. 1.

As described above, the array substrate 21 includes the transparent substrate 210. The TFTs 211 are formed on one major surface of the transparent substrate 210. Through holes which communicate with the source and drain of each TFT 211 are formed in the gate insulating film and interlayer dielectric film of the TFT 211. Source and drain electrodes 215 are formed on the insulating film 214. The source and drain electrodes 215 are connected to the source and drain of the TFT 211 through the through holes formed in the insulating film 214.

The insulating film 214 and source and drain electrodes 215 are covered with a passivation film 216. Through holes communicating with the source electrodes 215 are formed in the passivation film 216.

The pixel electrodes 212 are arrayed on the passivation film 216 in correspondence with the TFTs 211 while being spaced apart from each other. Each pixel electrode 212 is a transparent electrode and is connected to the source electrode 215 through the through hole formed in the passivation film 216.

The pixel electrodes 212 are covered with an alignment film 218. The alignment film 218 is a transparent resin layer made of, e.g. polyimide.

The counter substrate 22 has a transparent substrate 220 such as a glass substrate. A color filter 227, a counter electrode 222 as a transparent electrode, and an alignment film 228 are sequentially formed on the surface of the transparent substrate 220, which faces the array substrate 21. The color filter 227 includes green, blue, and red coloring layers formed into, e.g., stripes. The alignment film 228 is a transparent resin layer made of, e.g. polyimide.

A seal layer (not shown) made of an adhesive or the like is formed at the periphery between the array substrate 21 and the counter substrate 22 except the inlet for LC filling. The inlet is sealed by using a sealing agent (not shown). Columnar spacers (not shown) are formed on at least one of the opposing surfaces of the array substrate 21 and counter substrate 22 so that the gap between them becomes almost constant in plane. Alternatively, granular spacers (not shown) are arranged between the array substrate 21 and the counter substrate 22. The space surrounded by the array substrate 21, counter substrate 22, and seal layer is filled with a liquid crystal material. The liquid crystal material forms a liquid crystal layer 23.

A polarizer film 5a is stuck on the outer surface of the array substrate 21. A polarizer film 5b is stuck on the outer surface of the counter substrate 22.

A method of manufacturing the above-described liquid crystal display 1 will be described next.

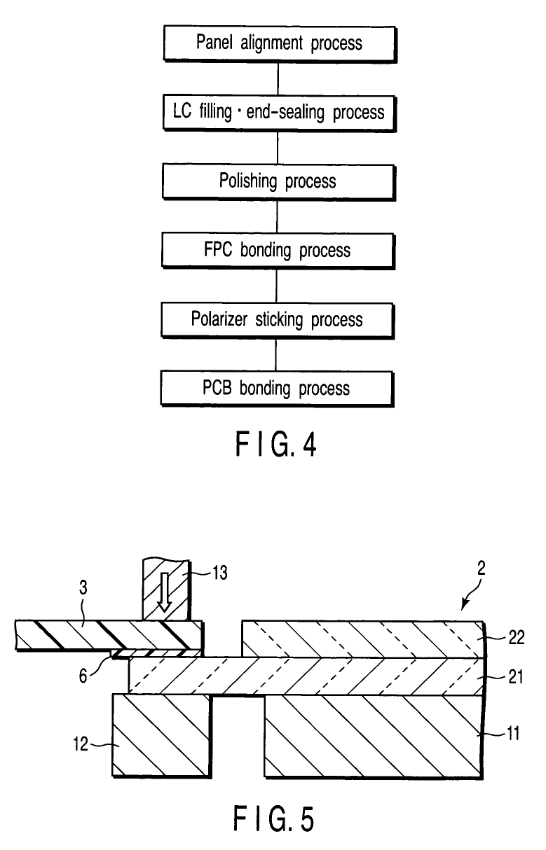

FIG. 4 is a flowchart schematically showing the liquid crystal display manufacturing method according to an embodiment of the present invention. FIG. 5 is a sectional view schematically showing the flexible printed circuit board (FPC) bonding process in the process shown in FIG. 4.

In this method, first, the array substrate 21 and counter substrate 22 are prepared. The array substrate 21 and counter substrate 22 can be manufactured by a normal method.

Next, a panel alignment process is executed. In the panel alignment process, an adhesive is applied to the peripheral portion of a surface of the array substrate 21 and/or counter substrate 22, on which the alignment film 218 or 228 is formed. The adhesive application is done such that the adhesive does not stick to a portion of the peripheral portion, which is to be used as the inlet for LC filling later. The array substrate 21 and counter substrate 22 are stuck such that the alignment films 218 and 228 face each other. In this state, the adhesive is heated and set to form the seal layer. With this process, an empty cell is obtained. When granular spacers are used as spacers, they are sprayed on one of the alignment films 218 and 228 before sticking the array substrate 21 to the counter substrate 22.

Next, a LC filling/end-sealing process is executed. In the LC filling/end-sealing process, first, the empty cell is filled with a liquid crystal material to form the liquid crystal layer 23. Subsequently, the liquid crystal inlet is sealed by a sealing agent. For example, the inlet is sealed by a UV curing resin. The resin is irradiated with UV rays and cured. With this process, the liquid crystal display panel 2 is completed.

After that, a polishing process is executed. More specifically, the surfaces of the transparent substrates 210 and 220 are polished to decrease the thickness of the liquid crystal display panel 2.

Next, an FPC bonding process is executed. In the FPC bonding process, an adhesive layer which covers the input terminal groups 213G of the array substrate 21 is formed, or an adhesive layer which covers the output terminal group of the flexible printed circuit board 3 is formed. The adhesive layer can be formed by sticking a film-shaped adhesive or applying a pasty adhesive. As the adhesive, an anisotropic conductive film (ACF) or anisotropic conductive paste (ACP) prepared by dispersing fine conductive particles in a resin such as a thermoplastic resin or thermoset resin, or a non-conductive film (NCF) or non-conductive paste (NCP) containing a resin such as a thermoplastic resin or thermoset resin as the principal component but no conductive fine particles can be used. Next, the end portion of the liquid crystal display panel 2 on the side of the input terminal groups 213G and the end portion of each flexible printed circuit board 3 on the output terminal group side are superposed such that the input terminal groups 213G of the array substrate 21 and the output terminal groups of the flexible printed circuit boards 3 face each other via the adhesive layer. In this state, the flexible printed circuit boards 3 are pressed against the array substrate 21 at the positions of the input terminal groups 213G.

More specifically, in this pressing, for example, as shown in FIG. 5, a portion almost corresponding to the display region of the liquid crystal display panel 2 is mounted on the flat supporting surface of a stage 11. In addition, a portion corresponding to the input terminal groups 213G and their periphery of the liquid crystal display panel 2 is located on the flat supporting surface of a stage 12. The end portion of each flexible printed circuit board 3 with the output terminal group is pressed against the supporting surface of the stage 12 by using a pressing member 13. At this time, nothing is interposed between the transparent substrate 210 and the supporting surface of the stage 12. Alternatively, only one or more layers each of which is difficult to be deformed as compared with the transparent substrate 210 when arranged on and pressed against the supporting surface is interposed between them. Typically, the adhesive is heated by using, e.g., a heater incorporated in the stage 12 and/or pressing member 13. With this process, the input terminal groups 213G of the array substrate 21 and the output terminal groups of the flexible printed circuit boards 3 are connected. In addition, the flexible printed circuit boards 3 are adhered to the array substrate 21 by an adhesive layer 6.

Next, a polarizer sticking process is executed. The polarizer film 5a is stuck on the outer surface of the array substrate 21. In addition, the polarizer film 5b is stuck on the outer surface of the counter substrate 22. Sticking the polarizer film 5b on the counter substrate 22 may be performed between the polishing process and the FPC bonding process.

Then, a printed circuit board (PCB) bonding process is executed. More specifically, for example, one end of the circuit board 4 is adhered to the end portion of each flexible printed circuit board 3, which is spaced apart from the liquid crystal display panel 2. In addition, the input terminal groups of the flexible printed circuit boards 3 and the output terminal groups of the circuit board 4 are connected by soldering or the like. In the above-described way, the structure shown in FIG. 1 is obtained.

In the FPC bonding process, if a layer (to be referred to as a soft layer hereinafter) such as the polarizer film 5a, which is easy to be deformed as compared with the transparent substrate 210 when arranged on and pressed against the supporting surface is interposed between the transparent substrate 210 and the supporting surface of the stage 12, the soft layer is deformed by pressing using the pressing member 13. This deformation of the soft layer takes place only at positions corresponding to the input terminal groups 213G of the array substrate 21. For this reason, when the soft layer is interposed between the transparent substrate 210 and the supporting surface of the stage 12, the array substrate 21 is deformed by pressing, and a local force is applied to the deformed array substrate 21. The array substrate 21 after the above-described polishing process is much more fragile than that before the polishing process. In the prior art, it seems that due to this reason, the yield in the process of bonding the flexible printed circuit boards to the liquid crystal display panel greatly decreases when the polishing process is executed.

To the contrary, in the method described above with reference to FIGS. 4 and 5, nothing is interposed between the transparent substrate 210 and the supporting surface of the stage 12 in the FPC bonding process. Alternatively, only one or more layers each of which is difficult to be deformed as compared with the transparent substrate 210 when arranged on and pressed against the supporting surface is interposed between them. For this reason, any deformation of the array substrate 21 by pressing can be prevented. Hence, the flexible printed circuit boards 3 can be bonded to the liquid crystal display panel 2 at a high yield.

Examples of the present invention will be described below.

### EXAMPLE 1

In this example, a liquid crystal display panel 2 shown in FIGS. 1 and 3 was manufactured by the following method.

First, an XGA array substrate 21 and counter substrate 22 were prepared by the normal method. As transparent substrates 210 and 220, 0.7-mm thick glass substrates were used. Light-shielding columnar spacers were formed on a color filter 227. A peripheral light-shielding layer was formed on the surface of the glass substrate 220 on which the color filter 227 was formed.

By using the printing method, an adhesive was applied to the peripheral portion of the surface of the counter substrate 22 on which an alignment film 228 was formed. This application of the adhesive was done such that a frame-shaped seal layer having an opening at a portion was obtained. To make it possible to apply a voltage to a counter electrode 222, a common transfer material was formed on the transfer pad.

The array substrate 21 and counter substrate 22 were put on top of each other such that the alignment films 218 and 228 faced each other. In this state, the adhesive was heated and set to form the seal layer. With this process, an empty cell was obtained.

The empty cell was filled by the normal method with a liquid crystal material, ZLI-1565 available from MERCK, so as to form a liquid crystal layer 23. The inlet was sealed by a UV curing resin. The resin was irradiated with UV rays and cured. With this process, the liquid crystal display panel 2 was completed.

Next, the transparent substrates 210 and 220 of the liquid crystal display panel 2 were polished to decrease the thickness to 0.3 mm or less. With this process, the liquid crystal display panel 2 was made lightweight and flexible.

As shown in FIG. 5, the liquid crystal display panel 2 was placed on stages 11 and 12 such that a portion almost corresponding to the display region was located on the stage 11, and a portion corresponding to input terminal groups 213G and their periphery was located on the stage 12. An ACF 6 was stuck to flexible printed circuit boards 3 to cover the output terminal groups. The end portion of the liquid crystal display panel 2 on the side of the input terminal groups 213G and the end portion of each flexible printed circuit board 3 on the output terminal group side were superposed such that the input terminal groups 213G of the array substrate 21 and the output terminal groups of the flexible printed circuit boards 3 faced each other via the ACF 6. In this state, the flexible printed circuit boards 3 were pressed against the array substrate 21 at the positions of the input terminal groups 213G by using a pressing member 13. The pressure was 35 kg/cm², and the heating temperature was 200° C. In this way, one end of each flexible printed circuit board 3 was bonded to the liquid crystal display panel 2.

As shown in FIG. 3, polarizer films 5a and 5b were stuck on both major surfaces of the liquid crystal display panel 2. The other end of each flexible printed circuit board 3 was bonded to a circuit board 4, thereby completing a liquid crystal display 1 shown in FIG. 1.

A number of liquid crystal displays 1 were manufactured by the above-described method. The cracking/chipping rate of the array substrates 21 was checked during the period from a point immediately before the start of the FPC bonding process to the end of the polarizer sticking process. As a result, the cracking/chipping rate of the array substrates 21 was 1 to 1% to 2%.

### EXAMPLE 2

Example 2 is a comparative example. In Example 2, a number of liquid crystal displays 1 were manufactured in accordance with the same procedures as described in Example 1 except that the polarizer bonding process was executed before the FPC bonding process. The cracking/chipping rate of array substrates 21 was checked during the period from a point immediately before the start of the polarizer sticking process to the end of the FPC bonding process. As a result, the cracking/chipping rate of the array substrates 21 was about 10%.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method of manufacturing a liquid crystal display, comprising:
assembling a liquid crystal display panel including an array substrate comprising a transparent substrate, pixel circuits which are arrayed in a display region on a major surface of the transparent substrate, and an input terminal group which is arranged in a peripheral region adjacent to the display region on the major surface of the transparent substrate and is connected to the pixel circuits, a counter substrate facing the pixel circuits, and a liquid crystal layer interposed between the array substrate and the counter substrate, a first portion of the major surface on which the input terminal group is arranged being exposed to an outside of the liquid crystal display panel; and
arranging the liquid crystal display panel on a supporting surface of a stage such that the array substrate faces the supporting surface and, in this state, pressing a second portion of a flexible printed circuit board on which an output terminal group is arranged against the first portion with an adhesive layer interposed between the first and second portions to connect the output terminal group to the input terminal group and to adhere the flexible printed circuit board to the liquid crystal display panel, wherein pressing the second portion against the first portion is performed in a state that no layer is interposed between the transparent substrate and the supporting surface or in a state that one or more layers are interposed between the transparent substrate and the supporting surface and all the layers between the transparent substrate and the supporting surface are difficult to be deformed as compared with the transparent substrate when arranged on and pressed against the supporting surface.

2. The method according to claim 1, further comprising polishing another major surface of the transparent substrate to decrease a thickness of the array substrate before connecting the output terminal group to the input terminal group and adhering the flexible printed circuit board to the liquid crystal display panel.

3. The method according to claim 2, wherein polishing the major surface of the transparent substrate is performed after assembling the liquid crystal display panel.

4. The method according to claim 2, wherein the transparent substrate includes a glass substrate, and the polished major surface is a major surface of the glass substrate.

5. The method according to claim 2, further comprising sticking a polarizer on the polished major surface of the transparent substrate after connecting the output terminal group to the input terminal group and adhering the flexible printed circuit board to the liquid crystal display panel.

6. The method according to claim 5, further comprising sticking a polarizer on a major surface of the counter substrate after polishing the major surface of the transparent substrate.

7. The method according to claim 1, wherein the transparent substrate includes a glass substrate.

8. The method according to claim 7, wherein pressing the second portion against the first portion is performed in a state that no layer is interposed between the glass substrate and the supporting surface.

9. The method according to claim 8, further comprising polishing a major surface of the glass substrate to decrease a thickness of the array substrate before connecting the output terminal group to the input terminal group and adhering the flexible printed circuit board to the liquid crystal display panel.

10. The method according to claim 9, further comprising sticking a polarizer on the polished major surface of the glass substrate after connecting the output terminal group to the input terminal group and adhering the flexible printed circuit board to the liquid crystal display panel.

11. The method according to claim 10, further comprising sticking a polarizer on a major surface of the counter substrate after polishing the major surface of the glass substrate.

12. The method according to claim 1, further comprising decreasing a thickness of the array substrate by polishing another major surface of the transparent substrate to make the liquid crystal display panel flexible before connecting the output terminal group to the input terminal group and adhering the flexible printed circuit board to the liquid crystal display panel.

13. The method according to claim 12, wherein the transparent substrate includes a glass substrate, and the polished major surface is a major surface of the glass substrate.

14. The method according to claim 12, further comprising sticking a polarizer on the polished major surface of the transparent substrate after connecting the output terminal group to the input terminal group and adhering the flexible printed circuit board to the liquid crystal display panel.

15. The method according to claim 14, further comprising sticking a polarizer on a major surface of the counter substrate after polishing the major surface of the transparent substrate.

16. The method according to claim 1, wherein pressing the second portion against the first portion is performed in the state that no layer is interposed between the transparent substrate and the supporting surface.

17. The method according to claim 16, further comprising polishing another major surface of the transparent substrate to decrease a thickness of the array substrate before connecting the output terminal group to the input terminal group and adhering the flexible printed circuit board to the liquid crystal display panel.

18. The method according to claim 16, wherein polishing the major surface of the transparent substrate is performed after assembling the liquid crystal display panel.

19. The method according to claim 17, further comprising sticking a polarizer on the polished major surface of the transparent substrate after connecting the output terminal group to the input terminal group and adhering the flexible printed circuit board to the liquid crystal display panel.

20. The method according to claim 19, further comprising sticking a polarizer on a major surface of the counter substrate after polishing the major surface of the transparent substrate.

21. A method of manufacturing a display, comprising:
preparing a glass substrate with a wire and an input terminal formed on a major surface thereof, the input terminal being connected to the wire for supplying the wire with a signal;
bonding a circuit board to the glass substrate, wherein bonding the circuit board includes arranging the glass substrate on a stage of a bonding apparatus such that the other major surface of the glass substrate comes in contact with a surface of the stage, arranging the circuit board on an input terminal portion of the glass substrate where the input terminal is formed, and pressing the circuit board against the glass substrate; and
after bonding the circuit board, forming a protective layer with a predetermined hardness on an area of the other major surface of the glass substrate which corresponds to the input terminal portion, wherein the surface of the stage which the other surface of the glass substrate contacts in bonding the circuit board has a hardness higher than the predetermined hardness.
